(19) United States
(12) Patent Application Publication
(10) Pub. No.: US 2026/0163103 A1
(43) Pub. Date: Jun. 11, 2026

(54) METHOD OF CONTROLLING A VEHICLE THERMAL MANAGEMENT SYSTEM

(71) Applicants: HYUNDAI MOTOR COMPANY, Seoul (KR); KIA CORPORATION, Seoul (KR)

(72) Inventors: Tae Woong Lim, Hwaseong-si (KR); Joon Hyung Park, Hwaseong-si (KR); Tae Eun Kim, Hwaseong-si (KR); Jun Ho Baek, Hwaseong-si (KR); Jung Ho Kwon, Hwaseong-si (KR); Ji Eun Kim, Hwaseong-si (KR)

(73) Assignees: HYUNDAI MOTOR COMPANY, Seoul (KR); KIA CORPORATION, Seoul (KR)

(21) Appl. No.: 19/230,486

(22) Filed: Jun. 6, 2025

(30) Foreign Application Priority Data
Dec. 9, 2024 (KR) 10-2024-0181921

(51) Int. Cl. H01M 10/633; B60H 1/00; B60H 1/14; H01M 10/615; H01M 10/625; H01M 10/6569; H01M 10/663

(52) U.S. Cl. CPC H01M 10/633; B60H 1/00278; B60H 1/00921; B60H 1/143; H01M 10/615; H01M 10/625; H01M 10/6569; H01M 10/663; B60H 2001/00307; B60H 2001/00928; H01M 2220/20

(57) ABSTRACT

A method of controlling a vehicle thermal management system includes determining, by a controller, a vehicle required heat amount based on an amount of heat required for cabin heating and an amount of heat required for battery warming-up when a heating, ventilation, and air conditioning (HVAC) subsystem operates in a heating mode; controlling, by the controller, operations of the HVAC subsystem and the coolant subsystem to minimize a work quantity of a compressor of the HVAC subsystem and minimize a heat release amount of a refrigerant circulating in the HVAC subsystem when the vehicle required heat amount is greater than a predetermined threshold; determining, by the controller, a heat absorption amount of the refrigerant; and increasing the work quantity of the compressor by a predetermined value when the heat absorption amount of the refrigerant is greater than the heat release amount of the refrigerant.

### CROSS-REFERENCE TO RELATED APPLICATION

This application claims the benefit of and priority to Korean Patent Application No. 10-2024-0181921, filed on Dec. 9, 2024, with the Korean Intellectual Property Office, the entire contents of which are incorporated herein by reference.

### TECHNICAL FIELD

The present disclosure relates to a method of controlling a vehicle thermal management system. More particularly, the present disclosure relates to a method of controlling a vehicle thermal management system designed to meet a required heat amount of a vehicle by optimally adjusting a quantity of compressor work and a heat release amount of a refrigerant based on the required heat amount.

### BACKGROUND

In recent years, with a growing interest in energy efficiency and environmental issues, there is a demand for development of eco-friendly vehicles that can replace internal combustion engine vehicles. Such eco-friendly vehicles are classified into electric vehicles, which are driven by using fuel cells or electricity as a power source, and hybrid vehicles, which are driven by using an engine and a battery.

Such eco-friendly vehicles may include a vehicle thermal management system for thermal management of a cabin (or a passenger compartment), a battery, a power electronics (PE) component, and the like. The vehicle thermal management system may include a heating, ventilation, and air conditioning (HVAC) subsystem for heating or cooling air discharged into the cabin. The vehicle thermal management system may further include a coolant subsystem for cooling the battery and/or the PE component. The HVAC subsystem may be thermally connected to the coolant subsystem through a battery chiller and a water-cooled heat exchanger. The battery chiller may include a refrigerant passage through which a refrigerant passes, and the battery chiller may further include a coolant passage through which a coolant passes. The water-cooled heat exchanger may include a refrigerant passage through which the refrigerant passes, and the water-cooled heat exchanger may further include a coolant passage through which the coolant passes.

The HVAC subsystem may include a refrigerant circulation path through which the refrigerant circulates, and the refrigerant circulation path may be fluidly connected to a compressor, an evaporator, an interior condenser, a heating-side expansion valve, an exterior heat exchanger, a cooling-side expansion valve, and the like.

When the HVAC subsystem operates in a heating mode in a condition in which the outdoor air temperature (or ambient temperature) of the vehicle is relatively low, the refrigerant may absorb heat from a heat source (the coolant passing through the coolant passage of the battery chiller, the coolant passing through the coolant passage of the water-cooled heat exchanger, the outdoor air, and/or the like). Specifically, the refrigerant may absorb heat from the outdoor air through the exterior heat exchanger. Alternatively, the refrigerant may absorb heat from the coolant passing through the coolant passage of the battery chiller and/or the coolant passing through the coolant passage of the water-cooled heat exchanger. However, when the outdoor air temperature of the vehicle is relatively low, the refrigerant may fail to sufficiently absorb heat from the heat source. Accordingly, the coefficient of performance (COP) of the HVAC subsystem may be relatively reduced in such a relatively low outdoor air temperature condition so that it may be difficult to meet a vehicle required heat amount set by a vehicle controller or a user. In this state, because an extra electric heater is needed, the consumption of electric energy may relatively increase.

In such a relatively low outdoor air temperature condition, a heat absorption amount of the refrigerant may be secured by relatively increasing the quantity of compressor work. However, in order to increase the quantity of compressor work, when work quantity (e.g., revolutions per minute, hereinafter “RPM”) of the compressor is increased unconditionally, a suction pressure of the compressor may be lowered below a threshold pressure. Accordingly, a density of the refrigerant flowing into an inlet of the compressor may be significantly reduced, and this may result in a decrease in the quantity of compressor work.

In addition, when the HVAC subsystem operates in the heating mode in the low temperature condition, and a minimum temperature of the refrigerant is relatively lowered below a freezing temperature of refrigerant oil contained in the refrigerant, the refrigerant oil contained in the refrigerant may freeze, and the density of the refrigerant may be reduced to thereby restrict the RPM of the compressor. Accordingly, the amount of heat released from the refrigerant to the cabin (hereinafter, referred to as “heat release amount of a refrigerant”) may be limited when the HVAC subsystem operates in the heating mode.

The above information described in this background section is provided to assist in understanding the background of the inventive concept and may include technical concepts, which are not considered as the prior art that is already known to those having ordinary skill in the art.

### SUMMARY

The present disclosure has been made to solve the above-mentioned problems occurring in the prior art while advantages achieved by the prior art are maintained intact.

An aspect of the present disclosure provides a method of controlling a vehicle thermal management system designed to meet a required heat amount of a vehicle by optimally adjusting a quantity of compressor work and a heat release amount of a refrigerant based on the required heat amount.

According to an aspect of the present disclosure, a method of controlling a vehicle thermal management system may include calculating or determining, by a controller, a vehicle required heat amount based on an amount of heat required for cabin heating and an amount of heat required for battery warming-up in a heating mode of a heating, ventilation, and air conditioning (HVAC) subsystem. The method may further include controlling, by the controller, operations of the HVAC subsystem and a coolant subsystem to minimize RPM or work quantity of a compressor of the HVAC subsystem and minimize a heat release amount of a refrigerant circulating in the HVAC subsystem based on the calculated or determined vehicle required heat amount being greater than a predetermined threshold. The method may further include calculating or determining, by the controller, a heat absorption amount of the refrigerant. The heat absorption amount of the refrigerant is the amount of heat absorbed by the refrigerant from a coolant, outdoor air, and the compressor. The method may further include increasing the work quantity or RPM of the compressor of the HVAC subsystem by a predetermined value based on the calculated or determined heat absorption amount of the refrigerant being greater than the heat release amount of the refrigerant.

The method may further include reducing, by the controller, the heat release amount of the refrigerant by a predetermined value based on the calculated or determined heat absorption amount of the refrigerant being less than or equal to the heat release amount of the refrigerant.

The method may further include determining, by the controller, a target mass flow rate (MF) of the refrigerant to meet the calculated or determined vehicle required heat amount. The target MF of the refrigerant may be determined based on the vehicle required heat amount, a current MF of the refrigerant, a maximum discharge pressure of the compressor, and a current discharge pressure of the compressor.

The method may further include determining, by the controller, a lower limit suction pressure of the compressor to meet the determined target MF of the refrigerant. The lower limit suction pressure of the compressor may be determined based on the target MF of the refrigerant, a maximum work quantity or RPM of the compressor, a current work quantity or RPM of the compressor, and a current suction pressure of the compressor.

The method may further include determining, by the controller, whether a suction pressure of the compressor is higher than a lower limit suction pressure after the work quantity or RPM of the compressor is increased. The method may further include determining, by the controller, whether a discharge pressure of the compressor is higher than an upper limit discharge pressure based on the suction pressure of the compressor being higher than the lower limit suction pressure.

The method may further include increasing, by the controller, the heat release amount of the refrigerant by a predetermined value based on the discharge pressure of the compressor being higher than the upper limit discharge pressure, and based on the vehicle required heat amount being greater than or equal to the heat release amount of the refrigerant.

The method may further include maintaining, by the controller, the heat release amount of the refrigerant based on the discharge pressure of the compressor being higher than the upper limit discharge pressure, and based on the vehicle required heat amount being less than the heat release amount of the refrigerant.

The method may further include reducing, by the controller, the RPM or work quantity of the compressor by a predetermined value based on the suction pressure of the compressor being lower than or equal to the lower limit suction pressure.

The method may further include reducing, by the controller, the RPM or work quantity of the compressor by a predetermined value based on the discharge pressure of the compressor being lower than or equal to the upper limit discharge pressure.

According to another aspect of the present disclosure, a method of controlling a vehicle thermal management system may include calculating or determining, by a controller, a vehicle required heat amount based on an amount of heat required for cabin heating and an amount of heat required for battery warming-up in a heating mode of a heating, ventilation, and air conditioning (HVAC) subsystem. The method may further include determining, by the controller, whether a second predetermined threshold is greater than a first predetermined threshold based on the vehicle required heat amount being greater than the first predetermined threshold. The method may further include controlling, by the controller, operations of the HVAC subsystem and a coolant subsystem to minimize work quantity or RPM of a compressor of the HVAC subsystem and minimize a heat release amount of a refrigerant circulating in the HVAC subsystem based on the second predetermined threshold being greater than the first predetermined threshold. The method may further include calculating or determining, by the controller, a heat absorption amount of the refrigerant. The heat absorption amount of the refrigerant is the amount of heat absorbed by the refrigerant from a coolant, outdoor air, and the compressor. The method may further include increasing the work quantity or RPM of the compressor of the HVAC subsystem by a predetermined value based on the calculated or determined heat absorption amount of the refrigerant being greater than the heat release amount of the refrigerant. The first predetermined threshold may be a maximum heat release amount of the refrigerant when the HVAC subsystem operates in a first heating mode. The second predetermined threshold may be a maximum heat release amount of the refrigerant when the HVAC subsystem operates in a second heating mode.

### BRIEF DESCRIPTION OF THE DRAWINGS

The above and other objects, features, and advantages of the present disclosure should be more apparent from the following detailed description taken in conjunction with the accompanying drawings:

FIG. 1 illustrates a vehicle thermal management system according to an embodiment of the present disclosure;

FIG. 2 illustrates a flowchart of a method of controlling a vehicle thermal management system according to an embodiment of the present disclosure; and

FIG. 3 illustrates a flowchart of a method of controlling a vehicle thermal management system according to another embodiment of the present disclosure.

### DETAILED DESCRIPTION

Hereinafter, embodiments of the present disclosure are described in detail with reference to the accompanying drawings. In the drawings, the same reference numerals are used throughout to designate the same or equivalent elements. In addition, a detailed description of well-known techniques associated with the present disclosure has been omitted in order not to unnecessarily obscure the gist of the present disclosure.

Terms, such as first, second, A, B, (a), and (b), may be used to describe the elements in embodiments of the present disclosure. These terms are only used to distinguish one element from another element. The intrinsic features, sequence,, order, or the like of the corresponding elements are not limited by the terms. Unless otherwise defined, all terms used herein, including technical or scientific terms, have the same meanings as those generally understood by those having ordinary skill in the art to which the present disclosure belongs. Such terms as those defined in a generally used dictionary should be interpreted as having meanings equal to the contextual meanings in the relevant field of art and should not be interpreted as having ideal or excessively formal meanings unless clearly defined as having such in the present disclosure. When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

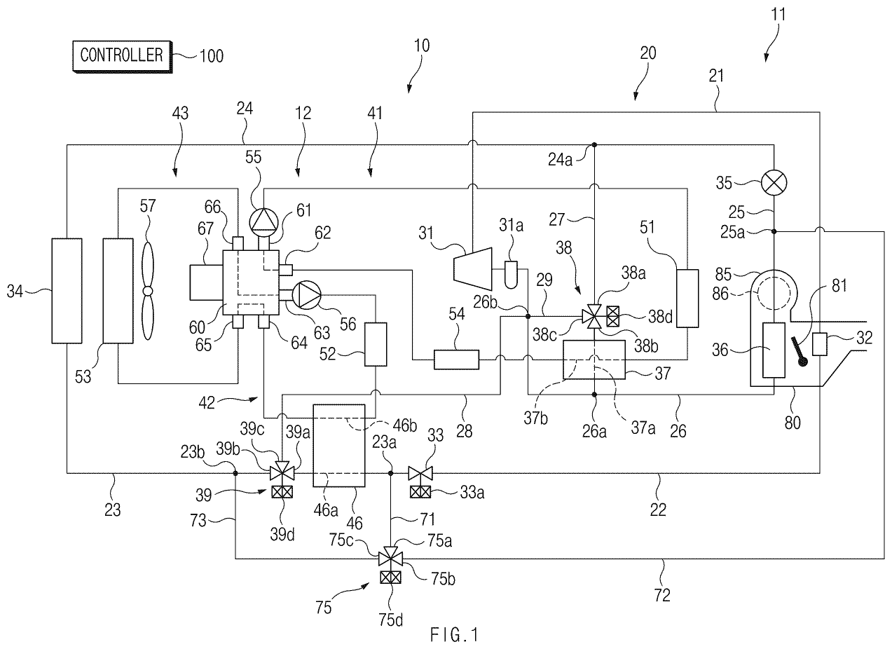

Referring to FIG. 1, a vehicle thermal management system 10 according to an embodiment of the present disclosure may include a heating, ventilation, and air conditioning (HVAC) subsystem 11 thermally connected to a cabin (or a passenger compartment) and may include a coolant subsystem 12 thermally connected to a battery 51 and/or a power electronics (PE) component 52.

The HVAC subsystem 11 may be configured to heat or cool air in the cabin of the vehicle using a refrigerant.

A refrigerant circulation path 20 may be configured to provide various circulation paths based on various operating modes such as an operating mode of the HVAC subsystem 11, the cooling and warming-up of the battery 51, and the cooling and warming-up of the PE component 52. As used herein, the terms “upstream” and “downstream” refer to a direction of flow of the refrigerant along the circulation path 20.

The HVAC subsystem 11 may include a compressor 31, an interior condenser 32, a heating-side expansion valve 33, an exterior heat exchanger 34, a cooling-side expansion valve 35, and an evaporator 36 fluidly connected through the refrigerant circulation path 20.

The compressor 31 may be configured to compress the refrigerant and allow the refrigerant to circulate. According to an embodiment, the compressor 31 may be an electric compressor driven by electric energy.

The interior condenser 32 may be disposed on the downstream side of the compressor 31, and the interior condenser 32 may be configured to condense the refrigerant received from the compressor 31. In other words, the refrigerant compressed by the compressor 31 may transfer heat to the air and be condensed in the interior condenser 32. Accordingly, the interior condenser 32 may heat the air using the refrigerant compressed by the compressor 31, and the air heated by the interior condenser 32 may be directed into the cabin.

The heating-side expansion valve 33 may be disposed on the downstream side of the interior condenser 32 on the refrigerant circulation path 20. Specifically, the heating-side expansion valve 33 may be disposed between the interior condenser 32 and the exterior heat exchanger 34. The heating-side expansion valve 33 may adjust the flow of the refrigerant and/or the flow rate of the refrigerant into the exterior heat exchanger 34 during a heating operation of the HVAC subsystem 11. The heating-side expansion valve 33 may be configured to expand the refrigerant received from the interior condenser 32 during the heating operation of the HVAC subsystem 11. The opening degree of the heating-side expansion valve 33 may be varied under the control of a controller 100. When the opening degree of the heating-side expansion valve 33 is varied, the flow rate of the refrigerant into the exterior heat exchanger 34 may be varied. In other words, the heating-side expansion valve 33 may be controlled by the controller 100 during the heating operation of the HVAC subsystem 11.

According to an embodiment, the heating-side expansion valve 33 may be an electronic expansion valve (EXV) having an actuator 33a. The actuator 33a may have a shaft, which is movable to open or close an orifice defined in a valve body of the heating-side expansion valve 33. The position of the shaft may be varied depending on the rotation direction, rotation degree, and the like of the actuator 33a, and accordingly the opening degree of the orifice of the heating-side expansion valve 33 may be varied. The controller 100 may control the operation of the actuator 33a. The heating-side expansion valve 33 may be a full open type EXV. When the HVAC subsystem 11 does not operate in a heating mode, the heating-side expansion valve 33 may be fully opened (the opening degree of the heating-side expansion valve 33 may be 100%) so that the refrigerant may pass through the heating-side expansion valve 33, and thus the expansion of the refrigerant may not be performed by the heating-side expansion valve 33.

The exterior heat exchanger 34 may be disposed adjacent to a front grille of the vehicle together with a radiator 53, and the exterior heat exchanger 34 may be configured to transfer heat between the refrigerant passing through an internal passage thereof and the air passing by an exterior surface of the exterior heat exchanger 34. An active air flap may adjust the opening degree of the front grille.

According to an embodiment, a cooling fan 57 may be located behind the exterior heat exchanger 34 and the radiator 53, and the exterior heat exchanger 34 and the radiator 53 may exchange heat with the outdoor air (or ambient air) forcibly blown by the cooling fan 57 so that a heat transfer rate between the exterior heat exchanger 34 and the radiator 53 may be further increased.

During a cooling operation of the HVAC subsystem 11, the exterior heat exchanger 34 may be configured to condense the refrigerant received from the interior condenser 32. In other words, the refrigerant passing through the exterior heat exchanger 34 may function as an exterior condenser that condenses the refrigerant by transferring heat to the ambient air during the cooling operation of the HVAC subsystem 11. During the heating operation of the HVAC subsystem 11, the exterior heat exchanger 34 may be configured to evaporate the refrigerant expanded by the heating-side expansion valve 33. In other words, the refrigerant passing through the internal passage of the exterior heat exchanger 34 may function as an exterior evaporator that evaporates the refrigerant by absorbing heat from the ambient air during the heating operation of the HVAC subsystem 11. In particular, the exterior heat exchanger 34 may exchange heat with the ambient air forcibly blown by the cooling fan 57 so that a heat transfer rate between the refrigerant passing through the internal passage of the exterior heat exchanger 34 and the ambient air may be further increased.

The cooling-side expansion valve 35 may be disposed on the downstream side of the exterior heat exchanger 34 on the refrigerant circulation path 20, and the cooling-side expansion valve 35 may be disposed between the exterior heat exchanger 34 and the evaporator 36 on the refrigerant circulation path 20. The cooling-side expansion valve 35 may be disposed on the upstream side of the evaporator 36 and may adjust the flow of the refrigerant and/or the flow rate of the refrigerant into the evaporator 36. The cooling-side expansion valve 35 may be configured to expand the refrigerant received from the exterior heat exchanger 34 during the cooling operation of the HVAC subsystem 11.

According to an embodiment, the cooling-side expansion valve 35 may be a thermal expansion valve (TXV), which senses the temperature and/or pressure of the refrigerant and adjusts the opening degree of the cooling-side expansion valve 35. Specifically, the cooling-side expansion valve 35 may be a TXV having a solenoid valve selectively blocking or unblocking the flow of the refrigerant into an internal passage of the cooling-side expansion valve 35. The solenoid valve may be opened or closed by the controller 100, and accordingly the solenoid valve may unblock or block the flow of the refrigerant into the cooling-side expansion valve 35. When the solenoid valve is opened, the refrigerant may be allowed to flow into the cooling-side expansion valve 35, and when the solenoid valve is closed, the refrigerant may be blocked from flowing into the cooling-side expansion valve 35. According to an embodiment, the solenoid valve may be mounted inside a valve body of the cooling-side expansion valve 35 and thus may open or close the internal passage of the cooling-side expansion valve 35. According to another embodiment, the solenoid valve may be disposed on the upstream side of the cooling-side expansion valve 35 and thus may selectively open or close an inlet of the cooling-side expansion valve 35. When the solenoid valve is closed, the refrigerant may be blocked from flowing into the cooling-side expansion valve 35 and the evaporator 36, and thus the cooling operation of the HVAC subsystem 11 may not be performed. When the solenoid valve is opened, the refrigerant may be directed to the cooling-side expansion valve 35 and the evaporator 36. In other words, when the solenoid valve of the cooling-side expansion valve 35 is opened to a predetermined opening degree, the cooling operation of the HVAC subsystem 11 may be performed.

The HVAC subsystem 11 may include an HVAC case 80 having a blower 86 configured to blow the heated or cooled air into the cabin. The HVAC case 80 may have an inlet and an outlet, and the HVAC case 80 may be configured to allow the air to be directed toward the cabin of the vehicle. The evaporator 36 and the interior condenser 32 may be located in the HVAC case 80. The evaporator 36 may be configured to evaporate the refrigerant and cool the air directed toward the cabin, and the interior condenser 32 may be configured to condense the refrigerant and heat the air directed toward the cabin.

An air mixing door 81 may be disposed between the evaporator 36 and the interior condenser 32. When the position of the air mixing door 81 is varied, the opening degree of a passage connected to the interior condenser 32 within the HVAC case 80 may be varied, and accordingly the flow rate of the air into the interior condenser 32 may be adjusted. When the position of the air mixing door 81 is varied, the flow rate of the air cooled by the evaporator 36 and the flow rate of the air heated by the interior condenser 32 may be mixed at a predetermined ratio. The air cooled, heated, and mixed by the evaporator 36, the interior condenser 32, and the air mixing door 81 within the HVAC case 80 may be directed toward a front seat region of the cabin through an air distributer unit.

The HVAC subsystem 11 may include a blower case 85 connected to the inlet of the HVAC case 80. The blower 86 may be received in the blower case 85, and the blower 86 may be disposed on the upstream side of the evaporator 36 in an air flow direction. The blower case 85 may include an inlet duct allowing the inflow of indoor air and/or outdoor air. In addition, the inlet duct may include an indoor air passage guiding the indoor air flow, an outdoor air passage guiding the outdoor air flow, and a switching door disposed between the indoor air passage and the outdoor air passage. The indoor air passage may communicate with the inside of the cabin, and the outdoor air passage may communicate with the outside of the cabin or the outside of the vehicle. The switching door may be activated by an actuator (not shown). The switching door may be configured to adjust the air flow between the indoor air passage and the outdoor air passage. The switching door may be configured to move to an indoor-air circulation position, an outdoor-air intake position, or an intermediate opening position. When the switching door is in the indoor-air circulation position, the switching door may block the outdoor air from flowing through the outdoor air passage and may allow only the indoor air to flow through the indoor air passage. When the switching door is in the outdoor-air intake position, the switching door may block the indoor air from flowing through the indoor air passage and may allow only the outdoor air to flow through the outdoor air passage. When the switching door is in the intermediate opening position, the switching door may allow the indoor air to flow through the indoor air passage and may allow the outdoor air to flow through the outdoor air passage. An indoor air fraction may be determined depending on the position of the switching door, and the indoor air fraction may be a ratio of an indoor-air intake flow rate and a total supply air flow rate. In particular, the indoor air fraction may be defined as a percent of the indoor air flowing into the cabin. When the switching door is in the indoor-air circulation position, the opening degree of the indoor air passage may be 100% and the opening degree of the outdoor air passage may be 0%, and thus the indoor air fraction may be 100%. When the switching door is in the outdoor-air intake position, the opening degree of the outdoor air passage may be 100% and the opening degree of the indoor air passage may be 0%, and thus the indoor air fraction may be 0%. When the switching door is in the intermediate opening position, the indoor air fraction may be equal to or be proportional to the opening degree of the indoor air passage. When the switching door is in the intermediate opening position, the opening degree of the indoor air passage may exceed 0% or be less than 100% when the position of the switching door is adjusted.

The HVAC subsystem 11 according to an embodiment of the present disclosure may further include an accumulator 31a located on the upstream side of the compressor 31. The accumulator 32a may separate a liquid refrigerant from the refrigerant and thus may prevent the liquid refrigerant from flowing into the compressor 31.

The refrigerant circulation path 20 may include a first line 21 extending from an outlet of the compressor 31 to the interior condenser 32, a second line 22 extending from the interior condenser 32 to the heating-side expansion valve 33, a third line 23 extending from the heating-side expansion valve 33 to the exterior heat exchanger 34, a fourth line 24 extending from the exterior heat exchanger 34 to the cooling-side expansion valve 35, a fifth line 25 extending from the cooling-side expansion valve 35 to the evaporator 36, and a sixth line 26 extending from the evaporator 36 to the compressor 31.

The HVAC subsystem 11 according to an embodiment of the present disclosure may further include a distribution line 27 configured to allow at least a portion of the refrigerant discharged from the exterior heat exchanger 34 to flow from an upstream point of the cooling-side expansion valve 35 to the compressor 31. The distribution line 27 may be configured to connect an upstream point 24a of the cooling-side expansion valve 35 and an upstream point of the compressor 31. An inlet of the distribution line 27 may be connected to the fourth line 24 of the refrigerant circulation path 20 at the upstream point 24a of the cooling-side expansion valve 35. An outlet of the distribution line 27 may be connected to the refrigerant circulation path 20 at the upstream point of the compressor 31. Specifically, the outlet of the distribution line 27 may be connected to the sixth line 26 of the refrigerant circulation path 20 at an upstream point 26a of the accumulator 31a located on the upstream side of the compressor 31. Accordingly, at least a portion of the refrigerant may be directed to the compressor 31 through the distribution line 27. The distribution line 27 may be configured to allow at least a portion of the refrigerant discharged from the exterior heat exchanger 34 to be directed to the compressor 31 while bypassing the cooling-side expansion valve 35 and the evaporator 36. Thus, the refrigerant may be distributed to the distribution line 27 and the fifth line 25 at a predetermined ratio.

A battery chiller 37 may be disposed on the distribution line 27, and the battery chiller 37 may be configured to exchange heat between the refrigerant passing through the distribution line 27 and a coolant passing through a battery coolant line 41. The battery chiller 37 may include a refrigerant passage 37a through which the refrigerant passes, and the battery chiller 37 a coolant passage 37b through which the coolant passes. The refrigerant passage 37a of the battery chiller 37 may be fluidly connected to the distribution line 27, and the refrigerant passing through the refrigerant passage 37a of the battery chiller 37 may absorb heat from the coolant passing through the coolant passage 37b of the battery chiller 37 so that the refrigerant may be heated or evaporated in the battery chiller 37, and the coolant may be cooled in the battery chiller 37. In other words, the refrigerant may absorb waste heat of the battery 51 through the battery chiller 37.

The HVAC subsystem 11 according to an embodiment of the present disclosure may further include a chiller bypass line 29 configured to allow at least a portion of the refrigerant passing through the distribution line 27 to bypass the refrigerant passage 37a of the battery chiller 37. The chiller bypass line 29 may be configured to allow the refrigerant to flow from an upstream point of the refrigerant passage 37a of the battery chiller 37 to a downstream point of the refrigerant passage 37a of the battery chiller 37. The chiller bypass line 29 may be configured to connect the upstream point of the refrigerant passage 37a of the battery chiller 37 and an upstream point 26b of the compressor 31. An inlet of the chiller bypass line 29 may be connected to the distribution line 27 at the upstream point of the refrigerant passage 37a of the battery chiller 37, and an outlet of the chiller bypass line 29 may be connected to the distribution line 27 at the upstream point 26b of the compressor 31. Accordingly, a portion of the refrigerant passing through the distribution line 27 may bypass the refrigerant passage 37a of the battery chiller 37 through the chiller bypass line 29 so that it may be directed to the compressor 31.

The HVAC subsystem 11 according to an embodiment of the present disclosure may further include a battery-side expansion valve 38 located on the upstream side of the battery chiller 37 on the distribution line 27.

The battery-side expansion valve 38 may be configured to adjust the flow of the refrigerant and/or the flow rate of the refrigerant into the refrigerant passage 37a of the battery chiller 37. The battery-side expansion valve 38 may be configured to expand the refrigerant received from the exterior heat exchanger 34. According to an embodiment, the battery-side expansion valve 38 may be an electronic expansion valve (EXV) having an actuator 38d. The controller 100 may control the operation of the actuator 38d.

The battery-side expansion valve 38 may have an inlet port 38a communicating with the exterior heat exchanger 34, and an outlet port 38b communicating with the refrigerant passage 37a of the battery chiller 37. The battery-side expansion valve 38 may include a valve housing and a valve member (configured to move by the actuator 38d in the valve housing.

The valve member may be configured to open or close the inlet port 38a by the actuator 38d. When the inlet port 38a is opened, the inlet port 38a may receive the refrigerant discharged from the exterior heat exchanger 34.

The valve member may be configured to adjust the opening degree of the outlet port 38b by the actuator 38d. When the temperature of the battery exceeds a predetermined threshold temperature (i.e., when the cooling of the battery is required because the waste heat of the battery is relatively high), the opening degree of the outlet port 38b may be adjusted by the valve member and the actuator 38d to meet a cooling load of the battery 51 so that the refrigerant may be expanded at the outlet port 38b, the flow rate of the refrigerant into the refrigerant passage 37a of the battery chiller 37 may be adjusted, and the expanded refrigerant may be directed to the refrigerant passage 37a of the battery chiller 37. The refrigerant passing through the refrigerant passage 37a of the battery chiller 37 may directly absorb heat from the coolant passing through the coolant passage 37b of the battery chiller 37 so that the refrigerant may be evaporated in the refrigerant passage 37a of the battery chiller 37. When the cooling of the battery 51 is required, the opening degree of the outlet port 38b may be adjusted so that the outlet port 38b may function as an expansion valve that expands the refrigerant flowing into the refrigerant passage 37a of the battery chiller 37.

According to an embodiment of the present disclosure, the battery-side expansion valve 38 may further include a bypass port 38c communicating with the chiller bypass line 29, and the valve member may be configured to adjust the opening degree of the bypass port 38c by the actuator 38d. When the bypass port 38c is opened, the refrigerant discharged from the bypass port 38c may be directed to the compressor 31 through the chiller bypass line 29.

The bypass port 38c may be directly connected to the chiller bypass line 29, and the opening degree of the bypass port 38c may be adjusted by the actuator 38d so that the flow rate of the refrigerant into the chiller bypass line 29 may be adjusted. The bypass port 38c may function as a flow control valve that adjusts the flow rate of the refrigerant bypassing the refrigerant passage 37a of the battery chiller 37.

The opening degree of the outlet port 38b and the opening degree of the bypass port 38c may be adjusted based on the temperature of the battery, and accordingly the flow rate of the refrigerant into the refrigerant passage 37a of the battery chiller 37 and the flow rate of the refrigerant passing through the chiller bypass line 29 may be adjusted at a predetermined ratio. For example, when the temperature of the battery is lower than or equal to the predetermined threshold temperature (i.e., when the waste heat of the battery is relatively reduced), the opening degree of the outlet port 38b may be relatively reduced, and the opening degree of the bypass port 38c may be relatively increased so that the flow rate of the refrigerant into the refrigerant passage 37a of the battery chiller 37 may be lower than the flow rate of the refrigerant passing through the chiller bypass line 29.

A water-cooled heat exchanger 46 may be disposed on the downstream side of the heating-side expansion valve 33, and the water-cooled heat exchanger 46 may be located between the heating-side expansion valve 33 and the exterior heat exchanger 34. The water-cooled heat exchanger 46 may include a refrigerant passage 46a through which the refrigerant passes, and the water-cooled heat exchanger 46 may include a coolant passage 46b through which the coolant passes.

The refrigerant passage 46a of the water-cooled heat exchanger 46 may be fluidly connected to the third line 23 of the refrigerant circulation path 20 of the HVAC subsystem 11, and accordingly at least a portion of the refrigerant may pass through the water-cooled heat exchanger 46 of the refrigerant circulation path 20. In other words, the refrigerant passage 46a of the water-cooled heat exchanger 46 may be fluidly connected to the third line 23 of the refrigerant circulation path 20 between the heating-side expansion valve 33 and the exterior heat exchanger 34.

When the HVAC subsystem 11 performs the heating operation, the refrigerant may be expanded by the heating-side expansion valve 33 and then may pass through the refrigerant passage 46a of the water-cooled heat exchanger 46. The refrigerant passing through the refrigerant passage 46a of the water-cooled heat exchanger 46 may absorb heat from the coolant passing through the coolant passage 46b of the water-cooled heat exchanger 46 so that the refrigerant may be evaporated in the water-cooled heat exchanger 46, and the coolant may be cooled in the water-cooled heat exchanger 46. In other words, during the heating operation of the HVAC subsystem 11, the water-cooled heat exchanger 46 may function as an evaporator that evaporates the refrigerant.

When the HVAC subsystem 11 performs the cooling operation, the heating-side expansion valve 33 may be fully opened so that the refrigerant may not be expanded in the heating-side expansion valve 33, the refrigerant passing through the refrigerant passage 46a of the water-cooled heat exchanger 46 may release heat to the coolant passing through the coolant passage 46b of the water-cooled heat exchanger 46 so that the refrigerant may be condensed in the water-cooled heat exchanger 46, and the coolant may be heated in the water-cooled heat exchanger 46. In other words, during the cooling operation of the HVAC subsystem 11, the water-cooled heat exchanger 46 may function as a condenser that condenses the refrigerant.

The HVAC subsystem 11 according to an embodiment of the present disclosure may further include a heating bypass line 28 configured to allow the refrigerant discharged from the refrigerant passage 46a of the water-cooled heat exchanger 46 to be directed to the compressor 31. The heating bypass line 28 may be configured to connect a downstream point of the refrigerant passage 46a of the water-cooled heat exchanger 46 and the upstream point 26b of the compressor 31. Specifically, an inlet of the heating bypass line 28 may be connected to the third line 23 of the refrigerant circulation path 20 at the downstream point of the refrigerant passage 46a of the water-cooled heat exchanger 46. An outlet of the heating bypass line 28 may be connected to the sixth line 26 of the refrigerant circulation path 20 at the upstream point 26b of the compressor 31. Accordingly, at least a portion of the refrigerant discharged from the refrigerant passage 46a of the water-cooled heat exchanger 46 may bypass the exterior heat exchanger 34 through the heating bypass line 28 so that it may directly flow from the refrigerant passage 46a of the water-cooled heat exchanger 46 to the compressor 31.

The HVAC subsystem 11 according to an embodiment of the present disclosure may further include a heating control valve 39 disposed at a point to which the heating bypass line 28 and the third line 23 of the refrigerant circulation path 20 are connected. The heating control valve 39 may be configured to control the flow of the refrigerant (the direction of the refrigerant, the flow rate of the refrigerant, and the like) among the refrigerant passage 46a of the water-cooled heat exchanger 46, the exterior heat exchanger 34, and the compressor 31. The heating control valve 39 may be configured to control the flow of the refrigerant in a manner that allows the refrigerant discharged from the refrigerant passage 46a of the water-cooled heat exchanger 46 to be selectively directed to the exterior heat exchanger 34 and/or the compressor 31.

The heating control valve 39 may include an inlet port 39a communicating with the refrigerant passage 46a of the water-cooled heat exchanger 46, a first outlet port 39b communicating with the exterior heat exchanger 34, a second outlet port 39c communicating with the heating bypass line 28, and an actuator 39d. The heating control valve 39 may include a valve housing, and a valve member configured to move by the actuator 39d in the valve housing.

In a state in which the heating control valve 39 performs a first switching operation to allow the inlet port 39a to communicate with the first outlet port 39b, the refrigerant discharged from the refrigerant passage 46a of the water-cooled heat exchanger 46 may be directed to the exterior heat exchanger 34.

In a state in which the heating control valve 39 performs a second switching operation to allow the inlet port 39a to communicate with the second outlet port 39c, the refrigerant discharged from the refrigerant passage 46a of the water-cooled heat exchanger 46 may be directed to the compressor 31 through the heating bypass line 28.

The HVAC subsystem 11 according to an embodiment of the present disclosure may further include a dehumidification bypass line 72 configured to allow the refrigerant discharged from the heating-side expansion valve 33 to be directed from an upstream point 23a of the refrigerant passage 46a of the water-cooled heat exchanger 46 to the evaporator 36. The dehumidification bypass line 72 may be configured to connect the upstream point 23a of refrigerant passage 46a of the water-cooled heat exchanger 46 and an upstream point 25a of the evaporator 36. Specifically, a branch line 71 may branch off from the point 23a between the heating-side expansion valve 33 and the refrigerant passage 46a of the water-cooled heat exchanger 46 on the second line 22. An inlet of the dehumidification bypass line 72 may be connected to the branch line 71, and an outlet of the dehumidification bypass line 72 may be connected to the fifth line 25 of the refrigerant circulation path 20 at the upstream point 25a of the evaporator 36.

The HVAC subsystem 11 according to an embodiment of the present disclosure may further include a heat exchanger bypass line 73 configured to allow at least a portion of the refrigerant discharged from the heating-side expansion valve 33 to bypass the refrigerant passage 46a of the water-cooled heat exchanger 46 and be directed to a downstream point 23b of the refrigerant passage 46a of the water-cooled heat exchanger 46. The heat exchanger bypass line 73 may be configured to connect the upstream point of the refrigerant passage 46a of the water-cooled heat exchanger 46 and the downstream point 23b of the refrigerant passage 46a of the water-cooled heat exchanger 46. Specifically, an inlet of the heat exchanger bypass line 73 may be connected to the branch line 71 at the upstream point of the refrigerant passage 46a of the water-cooled heat exchanger 46. An outlet of the heat exchanger bypass line 73 may be connected to the third line 23 of the refrigerant circulation path 20 at the downstream point 23b of the refrigerant passage 46a of the water-cooled heat exchanger 46. Accordingly, the refrigerant discharged from the heating-side expansion valve 33 may flow from the upstream point of the refrigerant passage 46a of the water-cooled heat exchanger 46 to the downstream point of the refrigerant passage 46a of the water-cooled heat exchanger 46 through the branch line 71 and the heat exchanger bypass line 73 so that at least a portion of the refrigerant discharged from the heating-side expansion valve 33 may bypass the refrigerant passage 46a of the water-cooled heat exchanger 46.

The HVAC subsystem 11 according to an embodiment of the present disclosure may further include a bypass control valve 75 disposed at a point to which the branch line 71, the dehumidification bypass line 72, and the heat exchanger bypass line 73 are connected. The bypass control valve 75 may be configured to control the flow of the refrigerant (the direction of the refrigerant, the flow rate of the refrigerant, and the like) among the heating-side expansion valve 33, the evaporator 36, and the exterior heat exchanger 34. The bypass control valve 75 may be configured to control the flow of the refrigerant in a manner that allows the refrigerant discharged from the heating-side expansion valve 33 to be selectively directed to at least one of the evaporator 36, the refrigerant passage 46a of the water-cooled heat exchanger 46, or the downstream point 23b of the refrigerant passage 46a of the water-cooled heat exchanger 46.

The bypass control valve 75 may include an inlet port 75a communicating with the branch line 71, a first outlet port 75b communicating with the dehumidification bypass line 72, and a second outlet port 75c communicating with the heat exchanger bypass line 73. The bypass control valve 75 may include a valve housing, and a valve member configured to move by an actuator 75d in the valve housing.

In a state in which the bypass control valve 75 performs a first switching operation to allow the inlet port 75a to be closed, the refrigerant discharged from the heating-side expansion valve 33 may be directed to the refrigerant passage 46a of the water-cooled heat exchanger 46.

In a state in which the bypass control valve 75 performs a second switching operation to allow the inlet port 75a to communicate with the first outlet port 75b, the refrigerant discharged from the heating-side expansion valve 33 may be directed to the evaporator 36 through the dehumidification bypass line 72. When dehumidification in the cabin is required during the heating operation of the HVAC subsystem 11, the bypass control valve 75 may perform the second switching operation so that at least a portion of the refrigerant discharged from the heating-side expansion valve 33 may be directed to the evaporator 36 through the dehumidification bypass line 72. Accordingly, the refrigerant directed to the evaporator 36 may cool the air passing by an exterior surface of the evaporator 36 so that the air flowing into the cabin may be dehumidified.

In a state in which the bypass control valve 75 performs a third switching operation to allow the inlet port 75a to communicate with the second outlet port 75c, the refrigerant discharged from the heating-side expansion valve 33 may bypass the refrigerant passage 46a of the water-cooled heat exchanger 46 and may be directed to the downstream point 23b of the refrigerant passage 46a of the water-cooled heat exchanger 46 through the branch line 71 and the heat exchanger bypass line 73, and the refrigerant may flow from the downstream point 23b of the refrigerant passage 46a of the water-cooled heat exchanger 46 to the exterior heat exchanger 34.

According to an embodiment of the present disclosure, the controller 100 may control the operation of an inverter of the compressor 31 in a manner that allows a motor section of the compressor 31 to operate in any one of an efficiency mode or a lossy mode. The inverter may be configured to allow the motor section to operate in any one of the efficiency mode or the lossy mode. An amount of heat generated from the compressor 31 when the motor section operates in the lossy mode may be greater than an amount of heat generated from the compressor 31 when the motor section operates in the efficiency mode. In other words, when the motor section operates in the lossy mode by the inverter, additional heat may be generated from the compressor 31.

The coolant subsystem 12 may include a battery coolant line 41 fluidly connected to the battery 51, a PE coolant line 42 fluidly connected to the PE component 52, and a radiator coolant line 43 fluidly connected to the radiator 53.

In addition, the coolant subsystem 12 may further include a coolant control valve 60 configured to allow the battery coolant line 41, the PE coolant line 42, and the radiator coolant line 43 to be fluidly connected to or separated from each other. In other words, the battery coolant line 41, the PE coolant line 42, and the radiator coolant line 43 may be fluidly connected to or separated from each other by various switching operations of the coolant control valve 60 so that the flow direction of the coolant among the battery coolant line 41, the PE coolant line 42, and the radiator coolant line 43 may be controlled.

The coolant control valve 60 may include a valve housing having a plurality of ports 61, 62, 63, 64, 65, and 66 individually connected to the battery coolant line 41, the PE coolant line 42, and the radiator coolant line 43, and a cylindrical valve member rotatable to selectively open or close the plurality of ports 61, 62, 63, 64, 65, and 66 in the valve housing. The valve member may have a plurality of passages therein, and the passages of the valve member may selectively communicate with the plurality of ports 61, 62, 63, 64, 65, and 66 by the rotation of the valve member so that each of the plurality of ports 61, 62, 63, 64, 65, and 66 may be opened or closed, or some of them may communicate with each other.

Specifically, the coolant control valve 60 may include a first battery-side port 61 connected to an inlet of the battery coolant line 41, a second battery-side port 62 connected to an outlet of the battery coolant line 41, a first PE-side port 63 connected to an inlet of the PE coolant line 42, a second PE-side port 64 connected to an outlet of the PE coolant line 42, a first radiator-side port 65 connected to an inlet of the radiator coolant line 43, and a second radiator-side port 66 connected to an outlet of the radiator coolant line 43.

The coolant control valve 60 may be switched to allow at least some of the first battery-side port 61, the second battery-side port 62, the first PE-side port 63, the second PE-side port 64, the first radiator-side port 65, or the second radiator-side port 66 to selectively communicate with each other under the control of the controller 100. Accordingly, the battery coolant line 41, the PE coolant line 42, and the radiator coolant line 43 may be selectively connected to or separated from each other, and the coolant subsystem 12 may operate in any one of a plurality of circulation modes in which various coolant flows are formed.

The coolant subsystem 12 according to an embodiment of the present disclosure may further include a reservoir 67 fluidly connected to the coolant control valve 60, and the reservoir 67 may be configured to temporarily store and replenish the coolant so that the circulating flow rate of the coolant may be maintained constant.

The battery coolant line 41 may be fluidly connected to a battery pump 55. The battery 51, a battery heater 54, and the coolant passage 37b of the battery chiller 37 may be fluidly connected to the battery coolant line 41.

The battery 51 may have a coolant passage provided inside or outside thereof, and the coolant may pass through the coolant passage. The battery coolant line 41 may be fluidly connected to the coolant passage of the battery 51.

The battery heater 54 may be disposed on the upstream or downstream side of the battery 51, and the battery heater 54 may be configured to heat the coolant circulating in the battery coolant line 41 so that the battery 51 may be warmed up by the heated coolant. According to an embodiment, the battery heater 54 may be an electric heater. According to another embodiment, the battery heater 54 may be a heater that heats the battery coolant by exchanging heat with a high-temperature fluid. Referring to FIG. 1, the battery heater 54 may be disposed on the downstream side of the battery 51 in a coolant flow direction.

The battery pump 55 may be configured to force the coolant to circulate, and an inlet of the battery pump 55 may communicate with the first battery-side port 61 of the coolant control valve 60. Accordingly, the coolant discharged from the first battery-side port 61 of the coolant control valve 60 may be sucked into the inlet of the battery pump 55. Referring to FIG. 1, the battery pump 55 may be disposed on the upstream side of the battery 51.

The battery chiller 37 may be disposed on the upstream or downstream side of the battery 51, and the battery chiller 37 may be configured to thermally connect the HVAC subsystem 11 and the battery coolant line 41. Referring to FIG. 1, the coolant passage 37b of the battery chiller 37 may be fluidly connected to the battery coolant line 41, and the refrigerant passage 37a of the battery chiller 37 may be fluidly connected to the distribution line 27 of the HVAC subsystem 11. The coolant passage 37b may be disposed on the upstream side of the battery heater 54, and the coolant passing through the coolant passage 37b may release heat to the refrigerant passing through the refrigerant passage 37a so that the coolant may be cooled in the battery chiller 37, and the refrigerant may be heated or evaporated in the battery chiller 37. An outlet of the coolant passage 37b may communicate with the second battery-side port 62 of the coolant control valve 60, and accordingly the coolant discharged from the coolant passage 37b may be directed to the second battery-side port 62 of the coolant control valve 60 through the battery heater 54.

The PE coolant line 42 may be fluidly connected to a PE pump 56. The PE component 52 and the water-cooled heat exchanger 46 may be fluidly connected to the PE coolant line 42.

The PE component 52 may have a coolant passage provided inside or outside thereof, and the coolant may pass through the coolant passage. The PE coolant line 42 may be fluidly connected to the coolant passage of the PE component 52.

The PE component 52 may include various components, such as an autonomous driving controller, an integrated charging control unit (ICCU), an inverter, and an electric motor.

The PE pump 56 may be configured to force the coolant to circulate, and an inlet of the PE pump 56 may communicate with the first PE-side port 63 of the coolant control valve 60. Accordingly, the coolant discharged from the first PE-side port 63 of the coolant control valve 60 may be sucked into the inlet of the PE pump 56 and be directed to the PE component 52. Referring to FIG. 1, the PE pump 56 may be disposed on the upstream side of the PE component 52.

The coolant passage 46b of the water-cooled heat exchanger 46 may be disposed on the upstream or downstream side of the PE component 52, and the water-cooled heat exchanger 46 may be configured to thermally connect the HVAC subsystem 11 and the PE coolant line 42. Referring to FIG. 1, the coolant passage 46b of the water-cooled heat exchanger 46 may be fluidly connected to the PE coolant line 42. The coolant passage 46b may be disposed on the downstream side of the PE component 52, and the coolant passing through the coolant passage 46b may release heat to the refrigerant passing through the refrigerant passage 46a so that the coolant may be cooled in the water-cooled heat exchanger 46, and the refrigerant may be heated or evaporated in the water-cooled heat exchanger 46. An outlet of the coolant passage 46b may communicate with the second PE-side port 64 of the coolant control valve 60, and accordingly the coolant discharged from the coolant passage 46b may be directed to the second PE-side port 64 of the coolant control valve 60. In other words, during the heating operation of the HVAC subsystem 11, the refrigerant may absorb waste heat of the PE component 52 through the water-cooled heat exchanger 46.

The radiator coolant line 43 may be configured to connect the coolant control valve 60 and the radiator 53. The inlet of the radiator coolant line 43 may communicate with the first radiator-side port 65 of the coolant control valve 60, and accordingly the coolant discharged from the first radiator-side port 65 of the coolant control valve 60 may be directed to an inlet of the radiator 53. The outlet of the radiator coolant line 43 may communicate with the second radiator-side port 66 of the coolant control valve 60, and accordingly the coolant discharged from an outlet of the radiator 53 may be directed to the second radiator-side port 66 of the coolant control valve 60.

The radiator 53 may be disposed adjacent to the front grille of the vehicle, and the radiator 53 may be configured to transfer heat between the coolant passing through an internal passage thereof and the air passing by an exterior surface of the radiator 53.

The controller 100 may control the operation of the coolant control valve 60 and the operation of the active air flap based on the temperature of the PE component 52, the temperature of the battery 51, the outdoor air temperature (or ambient temperature), the operating conditions of the HVAC subsystem 11, and the like.

According to an embodiment of the present disclosure, when the HVAC subsystem 11 operates in the heating mode, the controller 100 may be configured to appropriately control a quantity of work of the compressor 31 and a heat release amount Qᵣ of the refrigerant in a condition in which an amount of heat required for the heating of the cabin and/or the warming-up of the battery (hereinafter also referred to as the “vehicle required heat amount Q”) is greater than a predetermined threshold Q_{H} so as to meet the vehicle required heat amount.

The controller 100 may calculate or determine the vehicle required heat amount Q based on the amount of heat required for the heating of the cabin and the amount of heat required for the warming-up of the battery, and appropriately control the quantity of work of the compressor 31 and the heat release amount Qᵣ of the refrigerant based on the calculated or determined vehicle required heat amount Q.

The amount of heat required for the heating of the cabin may be set by a user or be automatically determined by the controller 100, and the amount of heat required for the warming-up of the battery may be determined by a battery management system or the controller 100.

According to an embodiment, the controller 100 may adjust a work quantity (e.g., revolutions per minute, hereinafter “RPM”) of the compressor 31. As the RPM of the compressor 31 is adjusted, the work quantity of the compressor 31 may be controlled.

The heat release amount Qᵣ of the refrigerant may be determined based on an air flow rate (AF) of the air passing through the interior condenser 32 and a difference between a temperature T₁ of the refrigerant discharged from the interior condenser 32 and a temperature T₂ of the cabin as shown in Equation 1 below.

$${Q}_{r} = AF \times ( {T}_{1} - {T}_{2} ) \qquad Equation 1$$

The heat release amount Qᵣ of the refrigerant may be determined based on the AF of the air passing through the interior condenser 32, the temperature T₁ of the refrigerant discharged from the interior condenser 32, and the temperature T₂ of the cabin.

According to an embodiment, the controller 100 may selectively control the operation of the blower 86, the operation of the air mixing door 81, the operation of the switching door of the blower case 85, the operation of the battery pump 55, and the operation of the PE pump 56 so that the flow rate of the air into the interior condenser 32, the indoor air fraction, the flow rate of the coolant into the battery chiller 37, the flow rate of the coolant into the water-cooled heat exchanger 46, and the like may be adjusted, and thus the heat release amount Qᵣ of the refrigerant may be controlled. Specifically, the controller 100 may adjust the RPM of the blower 86 so that the flow rate of the air into the interior condenser 32 may be adjusted, and accordingly the heat release amount of the refrigerant may be controlled. The controller 100 may adjust the position of the air mixing door 81 so that the flow rate of the air into the interior condenser 32 may be adjusted, and accordingly the heat release amount of the refrigerant may be controlled. When the position of the switching door of the blower case 85 is varied, the indoor air fraction of the HVAC case 80 may be adjusted, and accordingly the heat release amount of the refrigerant may be controlled. When the warming-up of the battery 51 is required, the controller 100 may adjust the RPM of the battery pump 55 so that the flow rate of the coolant into the battery chiller 37 may be adjusted, and accordingly the heat release amount of the refrigerant may be controlled. When the warming-up of the PE component 52 is required, the controller 100 may adjust the RPM of the PE pump 56 so that the flow rate of the coolant into the water-cooled heat exchanger 46 may be adjusted, and accordingly the heat release amount of the refrigerant may be controlled.

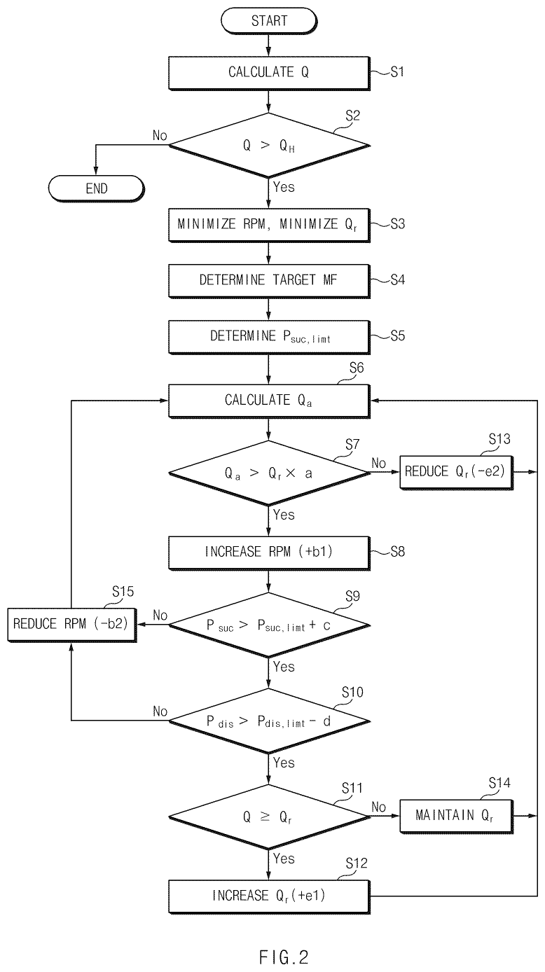

FIG. 2 illustrates a flowchart of a method of controlling a vehicle thermal management system according to an embodiment of the present disclosure.

When the HVAC subsystem 11 operates in a heating mode in a relatively low outdoor air temperature condition, the controller 100 may calculate or determine a vehicle required heat amount Q based on an amount of heat required for the heating of the cabin and an amount of heat required for the warming-up of the battery (S1).

The controller 100 may determine whether the vehicle required heat amount Q is greater than a predetermined threshold Q_{H} (S2). The predetermined threshold Q_{H} may be a maximum heat release amount of the refrigerant when the HVAC subsystem 11 operates in a first heating mode or a maximum heat release amount of the refrigerant when the HVAC subsystem 11 operates in a second heating mode. In other words, the controller 100 may determine whether it is required to perform the cabin heating in the first heating mode or the second heating mode. The first heating mode refers to a heating mode in which the vehicle required heat amount Q is satisfied by the heat absorption of the refrigerant. The second heating mode refers to a heating mode in which the vehicle required heat amount Q is satisfied by increasing the temperature and pressure of the refrigerant in a state in which the heat release of the refrigerant is stopped or minimized when it is estimated that the vehicle required heat amount Q is not satisfied by the heat absorption of the refrigerant.

When it is determined in S2 that the vehicle required heat amount Q is greater than the predetermined threshold Q_{H} (Yes in S2), the controller 100 may control the operation of the vehicle thermal management system 10 in a manner that minimizes the work quantity (e.g., RPM) of the compressor 31 and minimizes the heat release amount Qᵣ of the refrigerant (S3). The controller 100 may minimize the RPM of the compressor 31 and thus minimize the work quantity of the compressor 31. The controller 100 may selectively control the operations of at least some components of the HVAC subsystem 11 and at least some components of the coolant subsystem 12 so that the heat release amount Qᵣ of the refrigerant may be adjusted to almost zero (0) or be minimized. For example, the controller 100 may minimize the heat release amount Qᵣ of the refrigerant by minimizing the RPM of the blower 86, adjusting the air mixing door 81 to close or minimize the opening degree of the passage connected to the interior condenser 32 within the HVAC case 80, minimizing the RPM of the battery pump 55, and/or minimizing the RPM of the PE pump 56.

When it is determined in S2 that the vehicle required heat amount Q is not greater than the predetermined threshold QH (No in S2), the method according to this embodiment of the present disclosure may end.

The controller 100 may determine a target mass flow rate (MF) of the refrigerant to meet the calculated or determined vehicle required heat amount Q (S4). Specifically, the target MF of the refrigerant may be determined based on the vehicle required heat amount Q, a current MF of the refrigerant, a maximum discharge pressure of the compressor 31, and a current discharge pressure of the compressor 31. The target MF of the refrigerant may be determined from a map or table including the amount(s) of heat in relation to the following parameters: the maximum discharge pressure(s) of the compressor 31, the MF(s) of the refrigerant, and the current discharge pressure(s) of the compressor 31.

The controller 100 may determine a lower limit suction pressure P_{suc, limt} of the compressor 31 to meet the determined target MF of the refrigerant (S5). Specifically, the lower limit suction pressure P_{suc, limt} of the compressor 31 may be determined based on the target MF of the refrigerant, a maximum RPM of the compressor 31, a current RPM of the compressor 31, and a current suction pressure of the compressor 31. The lower limit suction pressure P_{suc, limt} of compressor 31 may be determined from an MF map or MF table including the mass flow rate(s) of the refrigerant in relation to the following parameters: the maximum RPM(s) of the compressor 31, the current RPM(s) of the compressor 31, and the current suction pressure(s) of the compressor 31.

The controller 100 may calculate or determine a heat absorption amount Qₐ of the refrigerant, which is the amount of heat absorbed by the refrigerant from the coolant, the outdoor air, the compressor 31, and the like (S6). Specifically, the heat absorption amount Qₐ of the refrigerant may be the sum of the amount of heat absorbed by the refrigerant from the coolant, the amount of heat absorbed by the refrigerant from the outdoor air, and the work quantity of the compressor 31. The refrigerant may absorb heat from the coolant through the battery chiller 37, and the refrigerant may absorb heat from the coolant through the water-cooled heat exchanger 46. When the compressor 31 operates, the refrigerant may absorb heat from the compressor 31, which means that the work quantity of the compressor 31 may be defined as the heat absorption amount of the refrigerant.

The controller 100 may determine whether the heat release amount Qᵣ of the refrigerant is less than the heat absorption amount Qₐ of the refrigerant. Specifically, the controller 100 may determine whether a heat release amount of the refrigerant corrected by a correction value a (Qᵣ×a) is less than the heat absorption amount Qₐ of the refrigerant (S7). The correction value a may be a value for adjusting a rate at which internal energy of the refrigerant increases during the heating operation of the HVAC subsystem 11. For example, the correction value a may be less than 1.

When it is determined in S7 that the heat release amount Qᵣ of the refrigerant or the corrected heat release amount (Qᵣ×a) of the refrigerant is less than the heat absorption amount Qₐ of the refrigerant (Yes in S7), the controller 100 may control the operation of the compressor 31 in a manner that increases the RPM of the compressor 31 by a predetermined value b1 (RPM+b1) (S8). The predetermined value b1 may be a value for stably increasing the operation of the compressor 31. In other words, in a state in which the heat release amount Qᵣ of the refrigerant or the corrected heat release amount (Qᵣ×a) of the refrigerant is less than the heat absorption amount Qₐ of the refrigerant, when the RPM of the compressor 31 is increased, the work quantity of the compressor 31 may be increased. When a suction pressure P_{suc} of the compressor 31 and a discharge pressure P_{dis} of the compressor 31 is increased, the density of the refrigerant in an inlet of the compressor 31 may be increased, and the work quantity of the compressor 31 may be increased, and accordingly the refrigerant may sufficiently absorb heat from the compressor 31 so that the vehicle required heat amount Q may be satisfied.

When it is determined in S7 that the heat release amount Qᵣ of the refrigerant or the corrected heat release amount (Qᵣ×a) of the refrigerant is greater than or equal to the heat absorption amount Qₐ of the refrigerant (No in S7), the controller 100 may control the operation of the vehicle thermal management system 10 in a manner that reduces the heat release amount Qᵣ of the refrigerant by a predetermined value e2 (Qᵣ−e2) (S13), and the method according to this embodiment of the present disclosure may return to S6. When the vehicle required heat amount Q is greater than the predetermined threshold Q_{H} and the heat release amount Qᵣ of the refrigerant or the corrected heat release amount (Qᵣ×a) of the refrigerant is greater than or equal to the heat absorption amount Qₐ of the refrigerant, the controller 100 may control the operation of the vehicle thermal management system 10 in a manner that reduces the heat release amount Qᵣ of the refrigerant by the predetermined value e2. The predetermined value e2 may be a value for reducing the heat release amount Qᵣ of the refrigerant to an appropriate level. In a state in which the vehicle required heat amount Q is greater than the predetermined threshold Q_{H} (i.e., it is required to perform the cabin heating in the first heating mode or the second heating mode), the controller 100 may control the operation of the vehicle thermal management system 10 in a manner that minimizes the heat release amount Qᵣ of the refrigerant so as to lower the heat release amount Qᵣ of the refrigerant or the corrected heat release amount (Qᵣ×a) of the refrigerant below the heat absorption amount Qₐ of the refrigerant before the work quantity of the compressor 31 is increased.

After the RPM of the compressor 31 is increased by the predetermined value b1, the controller 100 may determine whether the suction pressure P_{suc} of the compressor 31 is higher than an allowable lower limit suction pressure P_{suc, limt}. Specifically, the controller 100 may determine whether the suction pressure P_{suc} of the compressor 31 is higher than a corrected lower limit suction pressure (P_{suc, limt}+c) (S9). The corrected lower limit suction pressure (P_{suc, limt}+c) may be the sum of the lower limit suction pressure P_{suc, limt} and a first margin value c, and the first margin value c may be a margin value for allowing the lower limit suction pressure P_{suc, limt} of the compressor 31 to be maintained.

When it is determined in S9 that the suction pressure P_{suc} of the compressor 31 is higher than the lower limit suction pressure P_{suc, limt} or the corrected lower limit suction pressure (P_{suc, limt}+c) (Yes in S9), the controller 100 may determine whether the discharge pressure P_{dis} of the compressor 31 is higher than an allowable upper limit discharge pressure P_{dis, limt}. Specifically, the controller 100 may determine whether the discharge pressure P_{dis} of the compressor 31 is higher than a corrected upper limit discharge pressure (P_{dis, limt}−d) (S10). The corrected upper limit discharge pressure (P_{dis, limt}−d) may be obtained by subtracting a second margin value d from the upper limit discharge pressure P_{dis, limt}, and the second margin value d may be a margin value for allowing the upper limit discharge pressure P_{dis, limt} of the compressor 31 to be maintained.

When it is determined in S9 that the suction pressure P_{suc} of the compressor 31 is not higher than the lower limit suction pressure P_{suc, limt} or the corrected lower limit suction pressure (P_{suc, limt}+c) (No in S9), the controller 100 may control the operation of the compressor 31 in a manner that reduces the RPM of the compressor 31 by a predetermined value b2 (RPM−b2) (S15). When the suction pressure P_{suc} of the compressor 31 is lower than or equal to the lower limit suction pressure P_{suc, limt} or the corrected lower limit suction pressure (P_{suc, limt}+c), the RPM of the compressor 31 may be reduced so that the work quantity of the compressor 31 may be decreased. Accordingly, the suction pressure P_{suc} of the compressor 31 may be increased above the lower limit suction pressure P_{suc, limt}.

When it is determined in S10 that the discharge pressure P_{dis} of the compressor 31 is higher than the upper limit discharge pressure P_{dis, limt} or the corrected upper limit discharge pressure (P_{dis, limt}−d) (Yes in S10), the controller 100 may determine whether the vehicle required heat amount Q is greater than or equal to the heat release amount Qᵣ of the refrigerant (S11).

When it is determined in S10 that the discharge pressure P_{dis} of the compressor 31 is not higher than the upper limit discharge pressure P_{dis, limt} or the corrected upper limit discharge pressure (P_{dis, limt}−d) (No in S10), the controller 100 may control the operation of the compressor 31 in a manner that reduces the RPM of the compressor 31 by the predetermined value b2 (RPM−b2) (S15), and the method according to this embodiment of the present disclosure may return to S6. When the discharge pressure P_{dis} of the compressor 31 is lower than or equal to the upper limit discharge pressure P_{dis, limt} or the corrected upper limit discharge pressure (P_{dis, limt}−d), the of the compressor 31 may be reduced so that the work quantity of the compressor 31 may decrease. Accordingly, the discharge pressure P_{dis} of the compressor 31 may be increased above the upper limit discharge pressure P_{dis, limt}.

When it is determined in S11 that the vehicle required heat amount Q is greater than or equal to the heat release amount Qᵣ of the refrigerant(Yes in S11), the controller 100 may control the operation of the vehicle thermal management system 10 in a manner that increases the heat release amount Qᵣ of the refrigerant by a predetermined value e1 (S12). The predetermined value e1 may be a value for stably increasing the heat release amount Qᵣ of the refrigerant to an appropriate level. In the conditions in which the work quantity (e.g., RPM) of the compressor 31 increases, the suction pressure P_{suc} of the compressor 31 is higher than the lower limit suction pressure P_{suc, limt}, the discharge pressure P_{dis} of the compressor 31 is higher than the upper limit discharge pressure P_{dis, limt}, and the heat release amount Qᵣ of the refrigerant is less than the vehicle required heat amount Q, the heat release amount Qᵣ of the refrigerant may be increased to the maximum heat release amount so that the vehicle required heat amount Q may be reliably satisfied.

When it is determined in S11 that the vehicle required heat amount Q is less than the heat release amount Qᵣ of the refrigerant(No in S11), the controller 100 may control the operation of the vehicle thermal management system 10 in a manner that maintains the heat release amount Qᵣ of the refrigerant at a current level (S14), and the method according to this embodiment of the present disclosure may return to S6.

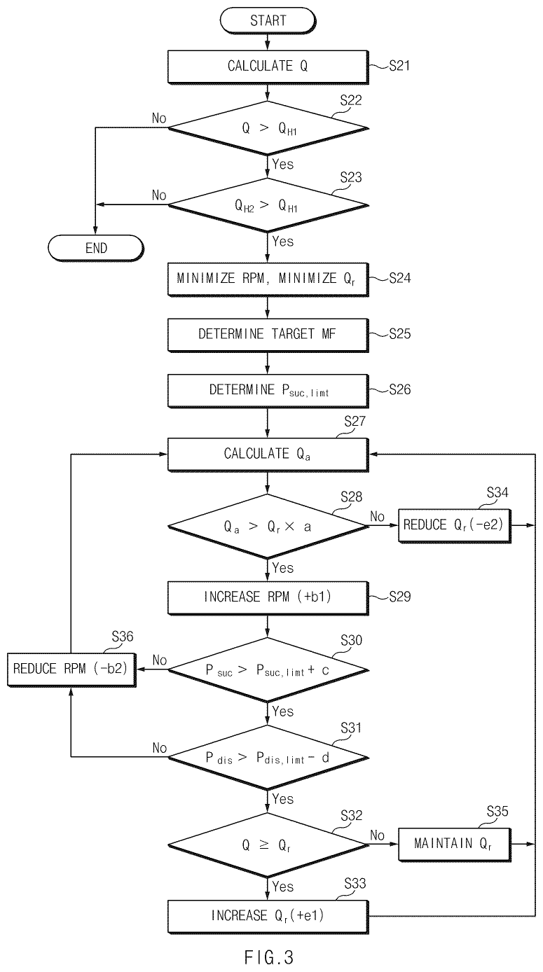

FIG. 3 illustrates a flowchart of a method of controlling a vehicle thermal management system according to another embodiment of the present disclosure.

The controller 100 may calculate or determine a vehicle required heat amount Q based on an amount of heat required for the heating of the cabin and an amount of heat required for the warming-up of the battery (S21).

The controller 100 may determine whether the vehicle required heat amount Q is greater than a first predetermined threshold Q_{H1} (S22). In other words, the controller 100 may determine whether it is required to perform the cabin heating in a first heating mode. The first predetermined threshold Q_{H1} may be a maximum heat release amount of the refrigerant when the HVAC subsystem 11 operates in the first heating mode. The first heating mode refers to a heating mode in which the vehicle required heat amount Q is satisfied by the heat absorption of the refrigerant.

When it is determined in S22 that the vehicle required heat amount Q is greater than the first predetermined threshold Q_{H1}(Yes in S22), the controller 100 may determine whether a second predetermined threshold Q_{H2} is greater than the first predetermined threshold Q_{H1} (S23). The second predetermined threshold Q_{H2} may be a maximum heat release amount of the refrigerant when the HVAC subsystem 11 operates in a second heating mode. The second heating mode refers to a heating mode in which the vehicle required heat amount Q is satisfied by increasing the temperature and pressure of the refrigerant in a state in which the heat release of the refrigerant is stopped or minimized when it is estimated that the vehicle required heat amount Q is not satisfied by the heat absorption of the refrigerant.

When it is determined in S22 that the vehicle required heat amount Q is less than or equal to the first predetermined threshold Q_{H1}(No in S22), the method according to this embodiment of the present disclosure may end. When the vehicle required heat amount Q is less than or equal to the first predetermined threshold Q_{H1}, the opening degree of the heating-side expansion valve 33 may be minimized so that the suction temperature and suction pressure of the compressor 31 may be relatively reduced. Accordingly, the heat absorption amount of the refrigerant may be relatively increased, and thus the vehicle required heat amount Q may be satisfied.

When it is determined in S23 that the second predetermined threshold Q_{H2} is greater than the first predetermined threshold Q_{H1}(Yes in S23), the controller 100 may determine that it is required to perform the cabin heating in the second heating mode. In other words, in the conditions in which the vehicle required heat amount Q is greater than the first predetermined threshold Q_{H1}, and the second predetermined threshold Q_{H2} is greater than the first predetermined threshold Q_{H1}, it may be required to perform the cabin heating in the second heating mode.

When it is determined in S23 that the second predetermined threshold Q_{H2} is greater than the first predetermined threshold Q_{H1}, the controller 100 may control the operation of the vehicle thermal management system 10 in a manner that minimizes the work quantity (e.g., RPM) of the compressor 31 and minimizes the heat release amount Qᵣ of the refrigerant (S24). The controller 100 may minimize the RPM of the compressor 31 so that the work quantity of the compressor 31 may be minimized. The controller 100 may selectively control the operations of at least some components of the HVAC subsystem 11 and at least some components of the coolant subsystem 12 so that the heat release amount Qᵣ of the refrigerant may be adjusted to almost zero (0) or be minimized. For example, the controller 100 may minimize the heat release amount Qᵣ of the refrigerant by minimizing the RPM of the blower 86, adjusting the air mixing door 81 to close or minimize the opening degree of the passage connected to the interior condenser 32 within the HVAC case 80, minimizing the RPM of the battery pump 55, and/or minimizing the RPM of the PE pump 56.

When it is determined in S23 that the second predetermined threshold Q_{H2} is not greater than the first predetermined threshold Q_{H1}(No in S23), the method according to this embodiment of the present disclosure may end. In a condition in which the second predetermined threshold Q_{H2} is less than or equal to the first predetermined threshold Q_{H1}, the opening degree of the heating-side expansion valve 33 may be minimized so that the suction temperature and suction pressure of the compressor 31 may be relatively reduced. Accordingly, the heat absorption amount of the refrigerant may be relatively increased, and thus the vehicle required heat amount Q may be satisfied.

The controller 100 may determine a target MF of the refrigerant to meet the calculated or determined vehicle required heat amount Q (S25). Specifically, the target MF of the refrigerant may be determined based on the vehicle required heat amount Q, a current MF of the refrigerant, a maximum discharge pressure of the compressor 31, and a current discharge pressure of the compressor 31. The target MF of the refrigerant may be determined from a map or table including the amount(s) of heat in relation to the following parameters: the maximum discharge pressure(s) of the compressor 31, the MF(s) of the refrigerant, and the current discharge pressure(s) of the compressor 31.

The controller 100 may determine a lower limit suction pressure P_{suc, limt} of the compressor 31 to meet the determined target MF of the refrigerant (S26). Specifically, the lower limit suction pressure P_{suc, limt} of the compressor 31 may be determined based on the target MF of the refrigerant, a maximum RPM of the compressor 31, a current RPM of the compressor 31, and a current suction pressure of the compressor 31. The lower limit suction pressure P_{suc, limt} of compressor 31 may be determined from an MF map or MF table including the mass flow rate(s) of the refrigerant in relation to the following parameters: the maximum RPM(s) of the compressor 31, the current RPM(s) of the compressor 31, and the current suction pressure(s) of the compressor 31.

The controller 100 may calculate or determine a heat absorption amount Qₐ of the refrigerant which is the amount of heat absorbed by the refrigerant from the coolant, the outdoor air, the compressor 31, and the like (S27). Specifically, the heat absorption amount Qₐ of the refrigerant may be the sum of the amount of heat absorbed by the refrigerant from the coolant, the amount of heat absorbed by the refrigerant from the outdoor air, and the work quantity of the compressor 31. The refrigerant may absorb heat from the coolant through the battery chiller 37, and the refrigerant may absorb heat from the coolant through the water-cooled heat exchanger 46. When the compressor 31 operates, the refrigerant may absorb heat from the compressor 31, which means that the work quantity of the compressor 31 may be defined as the heat absorption amount of the refrigerant.

The controller 100 may determine whether the heat release amount Qᵣ of the refrigerant is less than the heat absorption amount Qₐ of the refrigerant. Specifically, the controller 100 may determine whether a heat release amount of the refrigerant corrected by a correction value a (Qᵣ×a) is less than the heat absorption amount Qₐ of the refrigerant (S28). The correction value a may be a value for adjusting a rate at which internal energy of the refrigerant increases during the heating operation of the HVAC subsystem 11. For example, the correction value a may be less than 1.

When it is determined in S28 that the heat release amount Qᵣ of the refrigerant or the corrected heat release amount Qᵣ×a of the refrigerant is less than the heat absorption amount Qₐ of the refrigerant(Yes in S28), the controller 100 may control the operation of the compressor 31 in a manner that increases the RPM of the compressor 31 by a predetermined value b1 (RPM+b1) (S29). The predetermined value b1 may be a value for stably increasing the operation of the compressor 31. In other words, in a state in which the heat release amount Qᵣ of the refrigerant or the corrected heat release amount (Qᵣ×a) of the refrigerant is less than the heat absorption amount Qₐ of the refrigerant, when the RPM of the compressor 31 is increased, the work quantity of the compressor 31 may be increased. When a suction pressure P_{suc} of the compressor 31 and a discharge pressure P_{dis} of the compressor 31 are increased, the density of the refrigerant in the inlet of the compressor 31 may be increased, and the work quantity of the compressor 31 may be relatively increased, and accordingly the refrigerant may sufficiently absorb heat from the compressor 31 so that the vehicle required heat amount Q may be reliably satisfied.

When it is determined in S28 that the heat release amount Qᵣ of the refrigerant or the corrected heat release amount (Qᵣ×a) of the refrigerant is greater than or equal to the heat absorption amount Qₐ of the refrigerant(No in S28), the controller 100 may control the operation of the vehicle thermal management system 10 in a manner that reduces the heat release amount Qᵣ of the refrigerant by a predetermined value e2 (Qᵣ−e2) (S34), and the method according to this embodiment of the present disclosure may return to S27. When the vehicle required heat amount Q is greater than the first predetermined threshold Q_{H1}, the second predetermined threshold Q_{H2} is greater than the first predetermined threshold Q_{H1}, and the heat release amount Qᵣ of the refrigerant or the corrected heat release amount (Qᵣ×a) of the refrigerant is greater than or equal to the heat absorption amount Qₐ of the refrigerant, the controller 100 may control the operation of the vehicle thermal management system 10 in a manner that reduces the heat release amount Qᵣ of the refrigerant by the predetermined value e2. The predetermined value e2 may be a value for reducing the heat release amount Qᵣ of the refrigerant to an appropriate level. In a state in which the vehicle required heat amount Q is greater than the first predetermined threshold Q_{H1}, and the second predetermined threshold Q_{H2} is greater than the first predetermined threshold Q_{H1} (i.e., it is required to perform the cabin heating in the second heating mode), the controller 100 may control the operation of the vehicle thermal management system 10 in a manner that minimizes the heat release amount Qᵣ of the refrigerant so as to lower the heat release amount Qᵣ of the refrigerant or the corrected heat release amount (Qᵣ×a) of the refrigerant below the heat absorption amount Qₐ of the refrigerant before the work quantity of the compressor 31 is increased.

After the RPM of the compressor 31 is increased by the predetermined value b1, the controller 100 may determine whether the suction pressure P_{suc} of the compressor 31 is higher than an allowable lower limit suction pressure P_{suc, limt}. Specifically, the controller 100 may determine whether the suction pressure P_{suc} of the compressor 31 is higher than a corrected lower limit suction pressure (P_{suc, limt}+c) (S30). The corrected lower limit suction pressure (P_{suc, limt}+c) may be the sum of the lower limit suction pressure P_{suc, limt} and a first margin value c, and the first margin value c may be a margin value for allowing the lower limit suction pressure P_{suc, limt} of the compressor 31 to be maintained.

When it is determined in S30 that the suction pressure P_{suc} of the compressor 31 is higher than the lower limit suction pressure P_{suc, limt} or the corrected lower limit suction pressure (P_{suc, limt}+c) (Yes in S30), the controller 100 may determine whether the discharge pressure P_{dis} of the compressor 31 is higher than an allowable upper limit discharge pressure P_{dis, limt}. Specifically, the controller 100 may determine whether the discharge pressure P_{dis} of the compressor 31 is higher than a corrected upper limit discharge pressure (P_{dis, limt}−-d) (S31). The corrected upper limit discharge pressure (P_{dis, limt}−d) may be obtained by subtracting a second margin value d from the upper limit discharge pressure P_{dis, limt}, and the second margin value d may be a margin value for allowing the upper limit discharge pressure P_{dis, limt} of the compressor 31 to be maintained.

When it is determined in S30 that the suction pressure P_{suc} of the compressor 31 is not higher than the lower limit suction pressure P_{suc, limt} or the corrected lower limit suction pressure (P_{suc, limt}+c) (No in S30), the controller 100 may control the operation of the compressor 31 in a manner that reduces the RPM of the compressor 31 by a predetermined value b2 (RPM−b2) (S36). When the suction pressure P_{suc} of the compressor 31 is lower than or equal to the lower limit suction pressure P_{suc, limt} or the corrected lower limit suction pressure (P_{suc, limt}+c), the RPM of the compressor 31 may be reduced so that the work quantity of the compressor 31 may decrease. Accordingly, the suction pressure P_{suc} of the compressor 31 may be increased above the lower limit suction pressure P_{suc, limt}.

When it is determined in S31 that the discharge pressure P_{dis} of the compressor 31 is higher than the upper limit discharge pressure P_{dis, limt} or the corrected upper limit discharge pressure (P_{dis, limt}−d) (Yes in S31), the controller 100 may determine whether the vehicle required heat amount Q is greater than or equal to the heat release amount Qᵣ of the refrigerant (S32).

When it is determined in S31 that the discharge pressure P_{dis} of the compressor 31 is not higher than the upper limit discharge pressure P_{dis, limt} or the corrected upper limit discharge pressure (P_{dis, limt}−d) (No in S31), the controller 100 may control the operation of the compressor 31 in a manner that reduces the RPM of the compressor 31 by the predetermined value b2 (RPM−b2) (S36), and the method according to this embodiment of the present disclosure may return to S27. When the discharge pressure P_{dis} of the compressor 31 is lower than or equal to the upper limit discharge pressure P_{dis,} limt or the corrected upper limit discharge pressure (P_{dis, limt}−d), the RPM of the compressor 31 may be reduced so that the work quantity of the compressor 31 may decrease. Accordingly, the discharge pressure P_{dis} of the compressor 31 may be increased above the upper limit discharge pressure P_{dis, limt}.

When it is determined in S32 that the vehicle required heat amount Q is greater than or equal to the heat release amount Qᵣ of the refrigerant(Yes in S32), the controller 100 may control the operation of the vehicle thermal management system 10 in a manner that increases the heat release amount Qᵣ of the refrigerant by a predetermined value e1 (S33). The predetermined value e1 may be a value for stably increasing the heat release amount Qᵣ of the refrigerant to an appropriate level. In the conditions in which the work quantity (e.g., RPM) of the compressor 31 is increased, the suction pressure P_{suc} of the compressor 31 is higher than the lower limit suction pressure P_{suc, limt}, the discharge pressure P_{dis} of the compressor 31 is higher than the upper limit discharge pressure P_{dis, limt}, and the heat release amount Qᵣ of the refrigerant is less than the vehicle required heat amount Q, the heat release amount Qᵣ of the refrigerant may be increased to the maximum heat release amount so that the vehicle required heat amount Q may be reliably satisfied.

When it is determined in S32 that the vehicle required heat amount Q is less than the heat release amount Qᵣ of the refrigerant(No in S32), the controller 100 may control the operation of the vehicle thermal management system 10 in a manner that maintains the heat release amount Qᵣ of the refrigerant at a current level (S35), and the method according to this embodiment of the present disclosure may return to S27.

As set forth above, according to embodiments of the present disclosure, in a condition in which the vehicle required heat amount is greater than the predetermined threshold or it is required to perform the cabin heating in the second heating mode, the heat release amount of the refrigerant may be adjusted to be less than the heat absorption amount of the refrigerant. In this state, when the work quantity of the compressor is increased, the suction pressure of the compressor may be increased and the discharge pressure of the compressor may be increased so that the density of the refrigerant in the inlet of the compressor may be increased, and the work quantity of the compressor may be increased to the maximum level, and thus the vehicle required heat amount may be reliably satisfied.

According to embodiments of the present disclosure, after the work quantity of the compressor is increased, in the conditions in which the suction pressure of the compressor is higher than the lower limit suction pressure, the discharge pressure of the compressor is higher than the upper limit discharge pressure, and the heat release amount of the refrigerant is less than the vehicle required heat amount, the heat release amount of the refrigerant may be increased to the maximum heat release amount so that the vehicle required heat amount may be reliably satisfied.

Hereinabove, although the present disclosure has been described with reference to embodiments and the accompanying drawings, the present disclosure is not limited thereto. Instead, the present disclosure may be variously modified and altered by those having ordinary skill in the art to which the present disclosure pertains without departing from the spirit and scope of the present disclosure claimed in the following claims.

What is claimed is:

1. A method of controlling a vehicle thermal management system, the method comprising:
determining, by a controller, a vehicle required heat amount based on an amount of heat required for cabin heating and an amount of heat required for battery warming-up in a heating mode of a heating, ventilation, and air conditioning (HVAC) subsystem;
controlling, by the controller, operations of the HVAC subsystem and a coolant subsystem to minimize a work quantity of a compressor of the HVAC subsystem and minimize a heat release amount of a refrigerant circulating in the HVAC subsystem based on the determined vehicle required heat amount being greater than a predetermined threshold;
determining, by the controller, a heat absorption amount of the refrigerant, wherein the heat absorption amount of the refrigerant is the amount of heat absorbed by the refrigerant from a coolant, outdoor air, and the compressor; and
increasing the work quantity of the compressor of the HVAC subsystem by a predetermined value based on the determined heat absorption amount of the refrigerant being greater than the heat release amount of the refrigerant.

2. The method according to claim 1, further comprising
reducing, by the controller, the heat release amount of the refrigerant by a predetermined value based on the determined heat absorption amount of the refrigerant being less than or equal to the heat release amount of the refrigerant.

3. The method according to claim 1, further comprising:
determining, by the controller, a target mass flow rate (MF) of the refrigerant to meet the determined vehicle required heat amount,
wherein the target MF of the refrigerant is determined based on the vehicle required heat amount, a current MF of the refrigerant, a maximum discharge pressure of the compressor, and a current discharge pressure of the compressor.

4. The method according to claim 3, further comprising:
determining, by the controller, a lower limit suction pressure of the compressor to meet the determined target MF of the refrigerant,
wherein the lower limit suction pressure of the compressor is determined based on the target MF of the refrigerant, a maximum work quantity of the compressor, a current work quantity of the compressor, and a current suction pressure of the compressor.

5. The method according to claim 1, further comprising:
determining, by the controller, whether a suction pressure of the compressor is higher than a lower limit suction pressure after the work quantity of the compressor is increased; and
determining, by the controller, whether a discharge pressure of the compressor is higher than an upper limit discharge pressure based on the suction pressure of the compressor being higher than the lower limit suction pressure.

6. The method according to claim 5, further comprising:
increasing, by the controller, the heat release amount of the refrigerant by a predetermined value based on the discharge pressure of the compressor being higher than the upper limit discharge pressure, and based on the vehicle required heat amount being greater than or equal to the heat release amount of the refrigerant.

7. The method according to claim 5, further comprising:
maintaining, by the controller, the heat release amount of the refrigerant based on the discharge pressure of the compressor being higher than the upper limit discharge pressure, and based on the vehicle required heat amount being less than the heat release amount of the refrigerant.

8. The method according to claim 5, further comprising:
reducing, by the controller, the work quantity of the compressor by a predetermined value based on the suction pressure of the compressor being lower than or equal to the lower limit suction pressure.

9. The method according to claim 5, further comprising:
reducing, by the controller, the work quantity of the compressor by a predetermined value based on the discharge pressure of the compressor being lower than or equal to the upper limit discharge pressure.

10. A method of controlling a vehicle thermal management system, the method comprising:
determining, by a controller, a vehicle required heat amount based on an amount of heat required for cabin heating and an amount of heat required for battery warming-up in a heating mode of a heating, ventilation, and air conditioning (HVAC) subsystem;
determining, by the controller, whether a second predetermined threshold is greater than a first predetermined threshold based on the vehicle required heat amount being greater than the first predetermined threshold;
controlling, by the controller, operations of the HVAC subsystem and a coolant subsystem to minimize a work quantity of a compressor of the HVAC subsystem and minimize a heat release amount of a refrigerant circulating in the HVAC subsystem based on the second predetermined threshold being greater than the first predetermined threshold;
determining, by the controller, a heat absorption amount of the refrigerant, wherein the heat absorption amount of the refrigerant is the amount of heat absorbed by the refrigerant from a coolant, outdoor air, and the compressor; and
increasing the work quantity of the compressor of the HVAC subsystem by a predetermined value based on the determined heat absorption amount of the refrigerant being greater than the heat release amount of the refrigerant,
wherein the first predetermined threshold is a maximum heat release amount of the refrigerant when the HVAC subsystem operates in a first heating mode, and
wherein the second predetermined threshold is a maximum heat release amount of the refrigerant when the HVAC subsystem operates in a second heating mode.

11. The method according to claim 10, further comprising:
reducing, by the controller, the heat release amount of the refrigerant by a predetermined value based on the determined heat absorption amount of the refrigerant being less than or equal to the heat release amount of the refrigerant.

12. The method according to claim 10, further comprising:
determining, by the controller, a target mass flow rate (MF) of the refrigerant to meet the determined vehicle required heat amount,
wherein the target MF of the refrigerant is determined based on the vehicle required heat amount, a current MF of the refrigerant, a maximum discharge pressure of the compressor, and a current discharge pressure of the compressor.

13. The method according to claim 12, further comprising:
determining, by the controller, a lower limit suction pressure of the compressor to meet the determined target MF of the refrigerant,
wherein the lower limit suction pressure of the compressor is determined based on the target MF of the refrigerant, a maximum work quantity of the compressor, a current work quantity of the compressor, and a current suction pressure of the compressor.

14. The method according to claim 10, further comprising:
determining, by the controller, whether a suction pressure of the compressor is higher than a lower limit suction pressure after the work quantity of the compressor is increased; and
determining, by the controller, whether a discharge pressure of the compressor is higher than an upper limit discharge pressure based on the suction pressure of the compressor being higher than the lower limit suction pressure.

15. The method according to claim 14, further comprising:
increasing, by the controller, the heat release amount of the refrigerant by a predetermined value based on the discharge pressure of the compressor being higher than the upper limit discharge pressure, and based on the vehicle required heat amount being greater than or equal to the heat release amount of the refrigerant.

16. The method according to claim 14, further comprising
maintaining, by the controller, the heat release amount of the refrigerant based on the discharge pressure of the compressor being higher than the upper limit discharge pressure, and based on the vehicle required heat amount being less than the heat release amount of the refrigerant.

17. The method according to claim 14, further comprising:
reducing, by the controller, the work quantity of the compressor by a predetermined value based on the suction pressure of the compressor being lower than or equal to the lower limit suction pressure.

18. The method according to claim 14, further comprising:
reducing, by the controller, the work quantity of the compressor by a predetermined value based on the discharge pressure of the compressor being lower than or equal to the upper limit discharge pressure.
